(19) United States
(12) Patent Application Publication
(10) Pub. No.: US 2026/0332012 A1
(43) Pub. Date: Oct. 22, 2026

(54) VIBRATION GENERATING DEVICE

(71) Applicant: ALPS ALPINE CO., LTD., Tokyo (JP)

(72) Inventor: Yusuke KAZASHI, Miyagi (JP)

(21) Appl. No.: 19/468,301

(22) Filed: Feb. 3, 2026

Related U.S. Application Data
(63) Continuation of application No. PCT/JP2024/006248, filed on Feb. 21, 2024.

(30) Foreign Application Priority Data
Aug. 29, 2023 (JP) 2023-139211

(51) Int. Cl. H02K 33/18

(52) U.S. Cl. CPC H02K 33/18

(57) ABSTRACT

A vibration generating device includes a fixed body, a movable body, and a support member supporting the movable body to vibrate along a first direction with respect to the fixed body. The fixed body includes a coil having a bundle wire portion including conductive wires extending in a second direction orthogonal to the first direction, and disposed on one side of the movable body in a third direction orthogonal to the first and second directions. The movable body includes a permanent magnet generating a first magnetic flux toward the bundle wire portion and a second magnetic flux toward an opposite side. The fixed body further includes a conductive plate-like member on the other side of the movable body in the third direction and extending along the first direction to intersect the second magnetic flux, and configured to generate an eddy current when the movable body moves along the first direction.

### CROSS-REFERENCE TO RELATED APPLICATION

The present application is a continuation application of International Application No. PCT/JP2024/006248 filed on Feb. 21, 2024, which is based on and claims priority to Japanese Patent Application No. 2023-139211 filed on Aug. 29, 2023. The contents of these applications are incorporated herein by reference in their entirety.

### BACKGROUND OF THE INVENTION

### 1. Field of the Invention

The present disclosure relates to a vibration generating device.

### 2. Description of the Related Art

Conventionally, an actuator (a vibration generating device) for generating vibration is known (see Patent Document 1). This actuator is configured to reduce resonance when a movable body is vibrated, by a gel-like damper member disposed between a support and the movable body.

[Patent Document 1] Japanese Patent Application Laid-Open No. 2019-013086

### SUMMARY OF THE INVENTION

A vibration generating device according to an embodiment of the present disclosure includes:
a fixed body;
a movable body; and
a support member configured to support the movable body so as to be able to vibrate along a first direction with respect to the fixed body,
wherein the fixed body includes a coil that includes a bundled wire portion including a plurality of conductive wires extending in a second direction orthogonal to the first direction, the coil being disposed on one side of the movable body in a third direction orthogonal to the first direction and the second direction;
wherein the movable body includes a permanent magnet configured to generate:
   a first magnetic flux directed toward the bundled wire portion; and a second magnetic flux directed toward a side opposite to the bundled wire portion; and
   wherein the fixed body further includes a conductive plate-like member that is disposed on the other side of the movable body in the third direction, extends along the first direction so as to intersect the second magnetic flux, and is configured to generate an eddy current when the movable body moves along the first direction.

### BRIEF DESCRIPTION OF THE DRAWINGS

FIG. 1 is a view illustrating a configuration example of a vibration generating device.

FIG. 2 is an exploded perspective view of the vibration generating device.

FIG. 3 is a set of six orthogonal views of the support member.

FIG. 4 is a perspective view illustrating a movable body and the support member.

FIG. 5 is a front view and a bottom view of the movable body and the support member.

FIG. 6 is a top view and a cross-sectional view of the vibration generating device.

FIG. 7 is a top view illustrating a coil, the movable body, and the support member.

FIG. 8 is a front view illustrating a conductive plate-like member, the coil, the movable body, and the support member.

FIG. 9 is a top view illustrating the conductive plate-like member, the movable body, and the support member.

FIG. 10 is a cross-sectional view of the vibration generating device.

### DETAILED DESCRIPTION OF THE PREFERRED EMBODIMENTS

However, the above-described gel-like damper member may have durability issues. Therefore, it is desirable to provide a vibration generation device having a structure with excellent durability and capable of reducing resonance.

The vibration generating device described above has a structure with excellent durability and capable of reducing resonance.

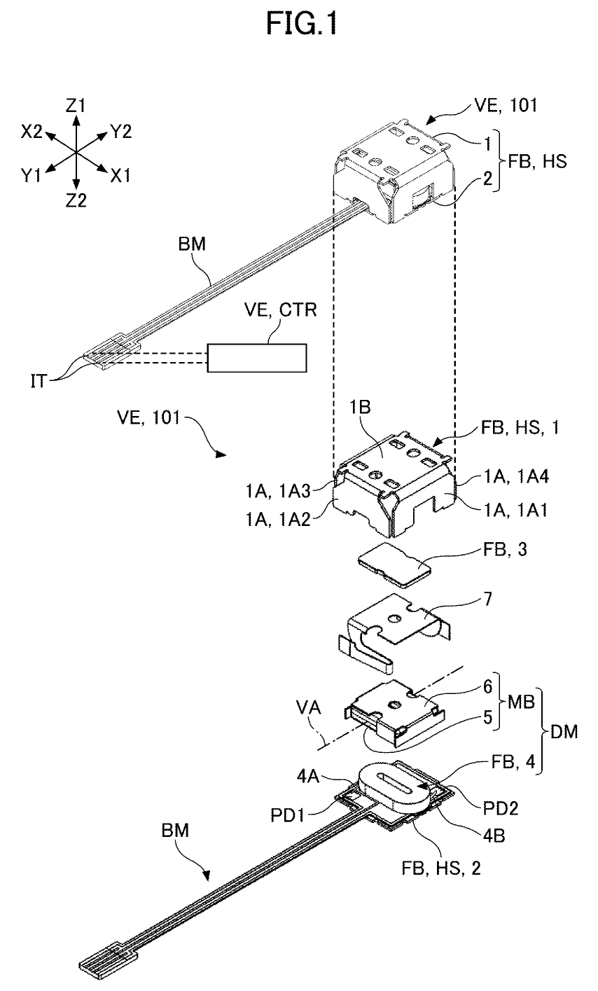

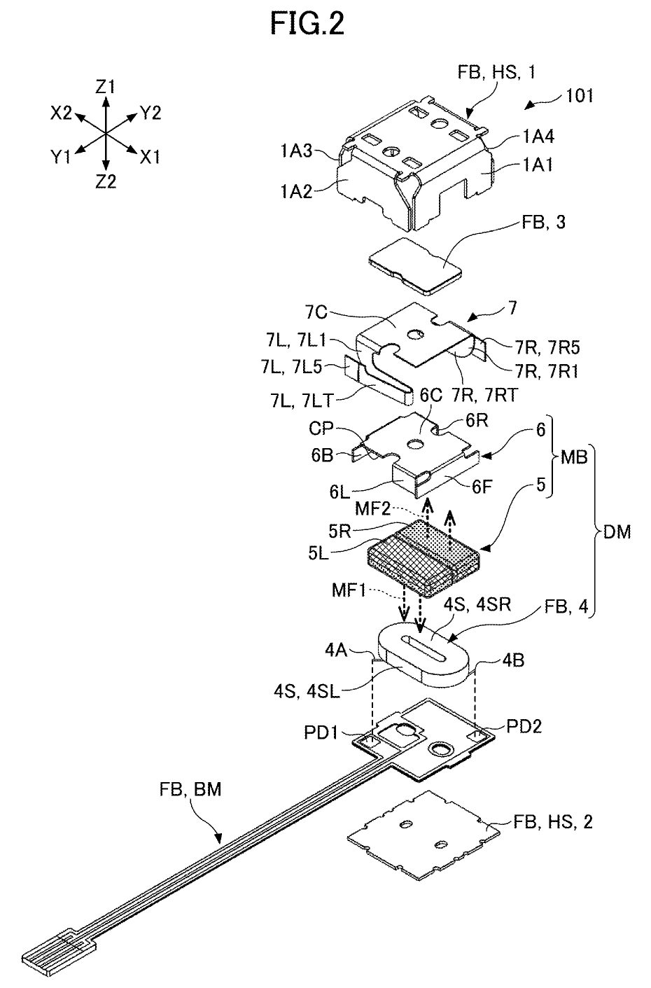

Hereinafter, a vibration generating device 101 according to an embodiment of the present disclosure will be described with reference to the drawings. FIG. 1 is a diagram illustrating an example configuration of the vibration generating device 101. Specifically, the upper view of FIG. 1 is a perspective view of the vibration generating device 101, and the lower view of FIG. 1 is an exploded perspective view of the vibration generating device 101. FIG. 2 is a more detailed exploded perspective view of the vibration generating device 101.

In FIGS. 1 and 2, X1 represents one direction of an X axis of a three-dimensional rectangular coordinate system, and X2 represents the other direction of the X axis. Further, Y1 represents one direction of a Y axis of the three-dimensional rectangular coordinate system, and Y2 represents the other direction of the Y axis. Similarly, Z1 represents one direction of a Z axis of the three-dimensional rectangular coordinate system, and Z2 represents the other direction of the Z axis. In this embodiment, the X1 side of the vibration generating device 101 corresponds to the front side (front surface side) of the vibration generating device 101, and the X2 side of the vibration generating device 101 corresponds to the rear side (rear surface side) of the vibration generating device 101. Further, the Y1 side of the vibration generating device 101 corresponds to the left side of the vibration generating device 101, and the Y2 side of the vibration generating device 101 corresponds to the right side of the vibration generating device 101. The Z1 side of the vibration generating device 101 corresponds to the upper side of the vibration generating device 101, and the Z2 side of the vibration generating device 101 corresponds to the lower side of the vibration generating device 101. The same applies to other drawings.

The vibration device VE includes a control unit CTR and the vibration generating device 101. The vibration generating device 101 is inserted into an elongated tubular object such as a stylus, for example, and is arranged to vibrate in a radial direction (short-side direction) of the tubular object. Therefore, the vibration generating device 101 is desirably configured such that a length dimension in the vibration direction is as small as possible as long as desired vibration power can be realized. Specifically, the vibration generating device 101 includes a housing HS serving as a box-like case, a movable body MB accommodated in the housing HS, a conductive plate-like member 3 attached to the housing HS, and a coil 4 attached to the housing HS via an insulating substrate BM. The housing HS, the conductive plate-like member 3, and the coil 4 form a fixed body FB. The control unit CTR is connected to an input terminal IT provided on the insulating substrate BM, which is fixed to the housing HS via an adhesive. In this embodiment, the insulating substrate BM is a combination of a flexible substrate and a rigid substrate. However, the insulating substrate BM may be a flexible substrate or a rigid-flexible substrate. Broken lines connecting the control unit CTR and the input terminal IT provided on the insulating substrate BM in the upper view of FIG. 1 schematically illustrate that the control unit CTR and the input terminal IT are electrically connected.

As illustrated in the upper view of FIG. 1, the housing HS has an outline of a substantially rectangular cuboid and is configured such that the areas of the surfaces (upper and lower surfaces) parallel to an XY plane are larger than those of the other surfaces. In this embodiment, the housing HS comprises a cover 1 and a base plate 2. The cover 1 is formed of a non-magnetic metal such as austenitic stainless steel. However, the cover 1 may be formed of a synthetic resin or a magnetic metal.

In the illustrated example, the cover 1 is configured such that five surfaces (upper, front, left, rear, and right) of the housing HS are formed by bending a single metal plate, as illustrated in the lower view of FIG. 1. Specifically, the cover 1 includes a tubular portion 1A having a substantially rectangular tubular shape and a top plate portion 1B having a substantially rectangular flat plate shape. The tubular portion 1A includes a front side plate portion 1A1, a left side plate portion 1A2, a rear side plate portion 1A3, and a right-side plate portion 1A4. More specifically, the tubular portion 1A includes the front side plate portion 1A1 and the rear side plate portion 1A3 facing each other, and the left side plate portion 1A2 and the right-side plate portion 1A4 that are orthogonal to the front side plate portion 1A1 and the rear side plate portion 1A3 and face each other.

The base plate 2 is configured to form a lower surface (bottom surface) of the housing HS. In the present embodiment, the base plate 2 forms a bottom plate portion having a substantially rectangular flat plate shape. In the illustrated example, the base plate 2 is formed of a magnetic metal and functions as a fixed-side magnetic member. The base plate 2 as the fixed-side magnetic member is configured to control a magnetic flux path of a magnetic field generated by the permanent magnet 5 as a movable-side magnetic field generating member. The base plate 2 as the fixed-side magnetic member is a component of a driving unit DM. However, the base plate 2 may be formed of a non-magnetic metal such as austenitic stainless steel.

The cover 1 is fixed to the base plate 2. Specifically, the cover 1 is joined to the base plate 2 by welding a lower end portion of the tubular portion 1A to the base plate 2. The lower end portion of the tubular portion 1A and the base plate 2 may be joined by brazing, adhesive, caulking, or the like. The insulating substrate BM is bonded to an upper surface of the base plate 2 by an adhesive.

The conductive plate-like member 3 is fixed to a ceiling surface (inner surface) of the cover 1 by double-sided tape, adhesive, caulking, or the like. In the illustrated example, the conductive plate-like member 3 is a copper plate and is fixed to the ceiling surface of the cover 1 by double-sided tape. The conductive plate-like member 3 may be formed of copper or aluminum.

The coil 4 is an example of a fixed-side magnetic field generating member and is configured to generate a magnetic field in a state of being fixed to the housing HS. The coil 4 is a component of the driving unit DM. In this embodiment, the coil 4 is a winding coil formed by winding a conductor whose surface is coated with an insulating material and is fixed to the insulating substrate BM by an adhesive. In FIGS. 1 and 2, for the sake of clarity, illustration of a detailed winding state of the conductor is omitted. The same applies to other drawings illustrating the coil 4.

Specifically, the coil 4 is arranged such that one end (a first end portion 4A) is connected to a first conductor pad PD1 formed on an upper surface of the insulating substrate BM, and the other end (a second end portion 4B) is connected to a second conductor pad PD2 formed on the upper surface of the insulating substrate BM, as illustrated in the lower diagram of FIG. 1.

The control unit CTR is configured to control the movement of the movable body MB. In this embodiment, the control unit CTR is a device including an electronic circuit and a nonvolatile memory device, and is configured to control the direction and magnitude of the current flowing through the coil 4. The control unit CTR may be configured to control the direction and magnitude of the current flowing through the coil 4 in response to a control command from an external device such as a computer, or may be configured to control the direction and magnitude of the current flowing through the coil 4 without receiving any control command from an external device. That is, the control unit CTR may be a microcomputer having a CPU. In this embodiment, the control unit CTR is disposed outside the housing HS, but may be disposed inside the housing HS.

The movable body MB is configured to vibrate the housing HS. In this embodiment, the movable body MB is configured to vibrate the housing HS by reciprocating within the housing HS while being supported by the support member 7.

Specifically, the movable body MB includes a permanent magnet 5 and a plate-like metal member 6, and is configured to be elastically supported by the support member 7. More specifically, the movable body MB has a predetermined natural frequency and is configured to reciprocate (vibrate) with respect to the housing HS along a vibration axis VA (see the lower view of FIG. 1) extending in a predetermined direction (Y-axis direction).

The permanent magnet 5 is configured to generate a magnetic field while being capable of reciprocating (vibrating) with respect to the housing HS. The permanent magnet 5 is a component of the driving unit DM. In this embodiment, as illustrated in FIG. 2, the permanent magnet 5 includes a left side magnet 5L and a right side magnet 5R magnetized to two poles in the Z-axis direction. In FIG. 2, for the sake of clarity, a cross pattern is attached to the S-pole portion of the permanent magnet 5, and a dot pattern is attached to the N-pole portion of the permanent magnet 5. The same is true in other drawings illustrating the polarity of the permanent magnet 5.

The plate-like metal member 6 is a member used for attaching the permanent magnet 5 to the support member 7. In the illustrated example, the plate-like metal member 6 is joined to the support member 7 by welding. The plate-like metal member 6 functions as a movable-side magnetic member and is configured to control the path of magnetic lines of force of the magnetic field generated by the permanent magnet 5. The plate-like metal member 6 is a component of the driving unit DM. In this embodiment, the plate-like metal member 6 includes a central portion 6C to which the permanent magnet 5 is attached, a rear side portion 6B arranged on the rear side of the central portion 6C, a front side portion 6F arranged on the front side of the central portion 6C, a left side portion 6L arranged on the left side of the central portion 6C, and a right side portion 6R arranged on the right side of the central portion 6C. In the example illustrated in FIGS. 1 and 2, the permanent magnet 5 is attracted to a ceiling surface CP of the plate-like metal member 6. The permanent magnet 5 and the plate-like metal member 6 may be fixed to each other by an adhesive. In this case, the plate-like metal member 6 may be formed of a non-magnetic metal, and the driving unit DM may be composed of the coil 4 and the permanent magnet 5.

The driving unit DM is an example of a vibration force generator and is configured to vibrate the movable body MB along the vibration axis VA. In this embodiment, the driving unit DM is an electromagnetic driving mechanism and is composed of the base plate 2 (fixed-side magnetic member), the coil 4 (fixed-side magnetic field generating member), the permanent magnet 5 (movable-side magnetic field generating member), and the plate-like metal member 6 (movable-side magnetic member). Specifically, the driving unit DM is configured to vibrate the movable body MB (the permanent magnet 5), which is elastically supported by the support member 7, along the vibration axis VA by utilizing a Lorentz force corresponding to the direction and magnitude of a current supplied to the coil 4 under the control of the control unit CTR.

The support member 7 is arranged between the fixed body FB (the housing HS) and the movable body MB and is configured to elastically support the movable body MB. In this embodiment, the support member 7 is a leaf spring formed of a metal plate and includes a left side elastic support portion 7L attached to the inner surface (the Y2-side surface) of the left side plate portion 1A2 of the housing HS, a right side elastic support portion 7R attached to the inner surface (the Y1-side surface) of the right side plate portion 1A4 of the housing HS, and a central portion 7C provided between the left side elastic support portion 7L and the right side elastic support portion 7R. In the illustrated example, the central portion 7C functions as a connecting plate portion connecting the left side elastic support portion 7L and the right-side elastic support portion 7R. The central portion 7C may be omitted. In this case, the left side elastic support portion 7L and the right-side elastic support portion 7R are separate and independent members and are fixed separately to the movable body MB.

Further, the support member 7 may include a reinforcing plate portion for reducing deformation of the central portion 7C. Specifically, the reinforcing plate portion includes, for example, at least one of a front extending portion extending downward from the front edge portion of the central portion 7C and a rear extending portion extending downward from the rear edge portion of the central portion 7C.

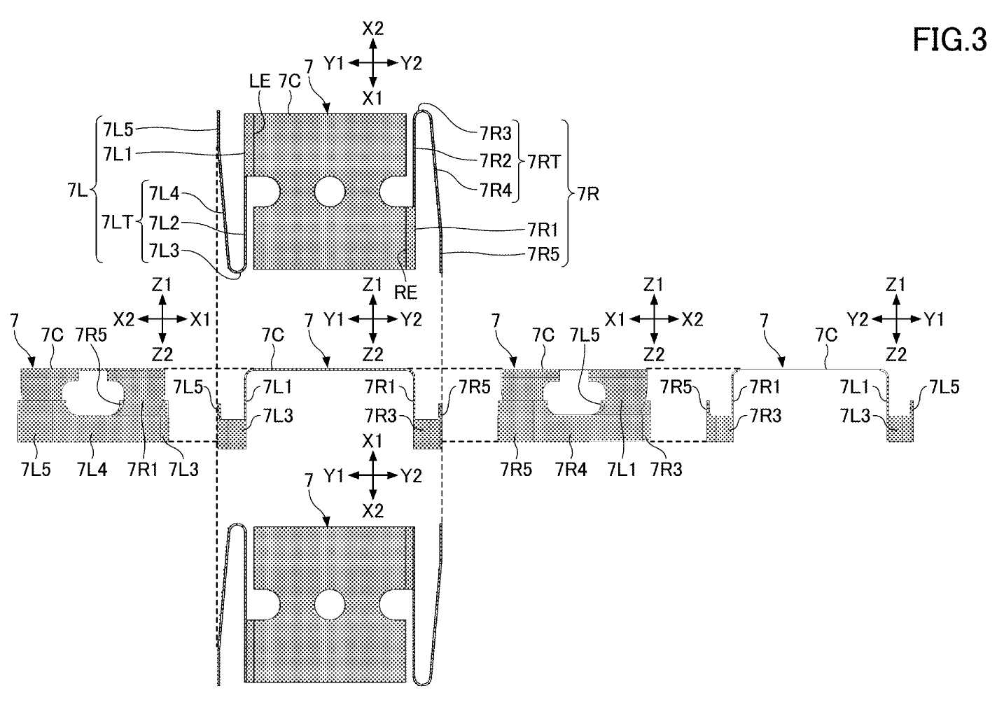

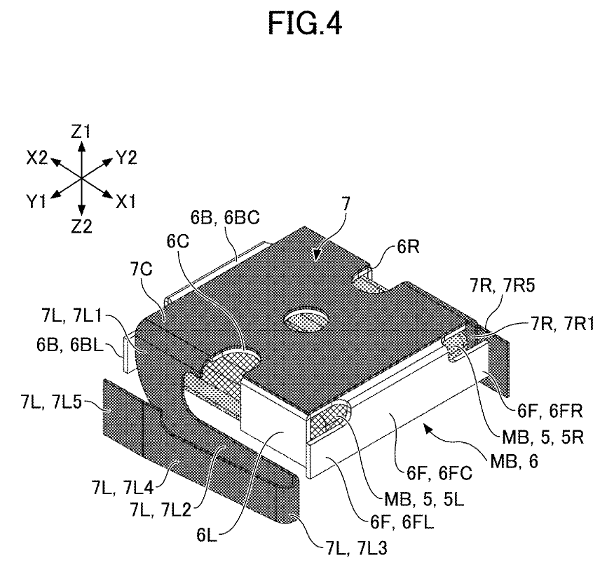

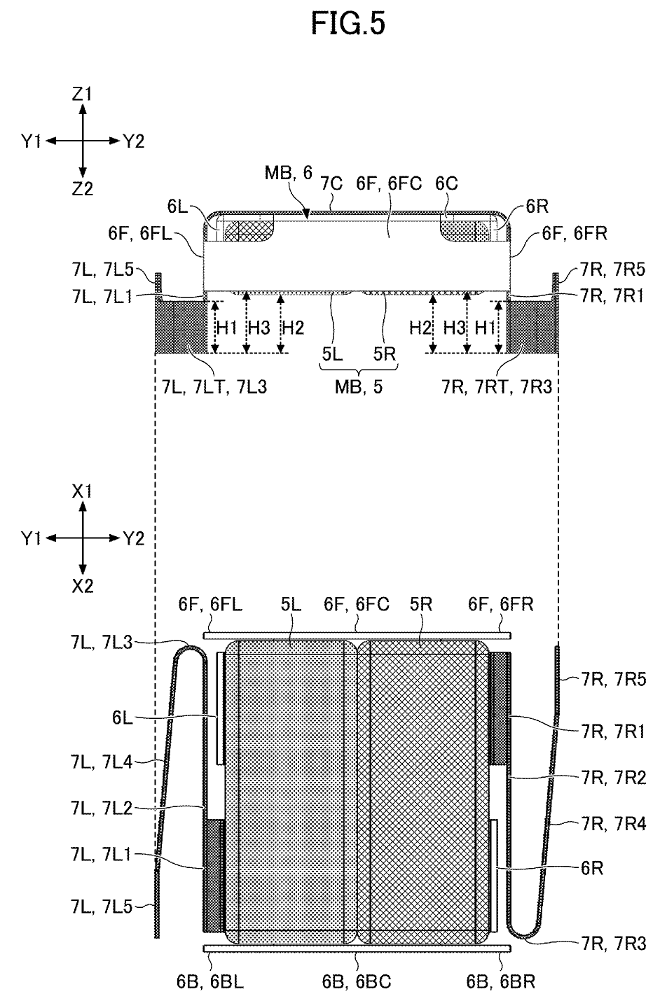

The details of the support member 7 will now be described with reference to FIGS. 3, 4, and 5. FIG. 3 is a set of six orthogonal views of the support member. FIGS. 4 and 5 are views illustrating the support member 7 for supporting the movable body MB (the permanent magnet 5 and the plate-like metal member 6) so as to be able to reciprocate. Specifically, FIG. 4 is a perspective view illustrating the permanent magnet 5, the plate-like metal member 6, and the support member 7; the upper view of FIG. 5 is a front view illustrating the permanent magnet 5, the plate-like metal member 6, and the support member 7; and the lower view of FIG. 5 is a bottom view illustrating the permanent magnet 5, the plate-like metal member 6, and the support member 7.

The central portion 7C is configured to be fixed to the upper surface of the plate-like metal member 6. In this embodiment, the lower surface of the central portion 7C is fixed to the upper surface of the plate-like metal member 6 by welding.

The left side elastic support portion 7L is a portion that elastically supports the movable body MB, and includes a left side upright portion 7L1, a first left side deformed portion 7L2, a left side folded portion 7L3, a second left side deformed portion 7L4, and a left side fixed portion 7L5. The left side upright portion 7L1 is a portion that connects a left end portion LE of the central portion 7C (see the top view of FIG. 3) to the first left side deformed portion 7L2. In this embodiment, the left side upright portion 7L1 is formed by bending using the left end portion LE of the central portion 7C extending in the X-axis direction as a fold line. The left side upright portion 7L1 includes a portion formed linearly in a front view. In this embodiment, the left side upright portion 7L1 is configured to extend downward (in the Z2 direction) orthogonal to the central portion 7C. The first left side deformed portion 7L2 is a portion formed linearly in a top view. In this embodiment, the first left side deformed portion 7L2 is configured to extend forward (in the X1 direction) from the left side upright portion 7L1. The left side folded portion 7L3 extends leftward (in the Y1 direction) from the front end of the first left side deformed portion 7L2 and is curved so as to be convex toward the front. In this embodiment, the left side folded portion 7L3 is configured to have a U-shape when viewed from above so that stress acting on the left side folded portion 7L3 is distributed over a wide range. The second left side deformed portion 7L4 is a rectilinear portion that extends rearward (in the X2 direction) from the left end of the left side folded portion 7L3. The left side fixed portion 7L5 is a portion that is fixed to the housing HS. In this embodiment, the left side fixed portion 7L5 extends upward (in the Z1 direction) from the rear end of the second left side deformed portion 7L4 in parallel with the left side plate portion 1A2 of the cover 1 and is fixed to the left side plate portion 1A2 by welding. However, the left side fixed portion 7L5 may be fixed to other portions of the housing HS, such as the front side plate portion 1A1, the rear side plate portion 1A3, the top plate portion 1B, or the base plate 2, by welding or the like. The first left side deformed portion 7L2, the left side folded portion 7L3, and the second left side deformed portion 7L4 are also referred to as the left side deformed portion 7LT (see the top view of FIG. 3), which is a portion that deforms in response to the reciprocating motion of the movable body MB.

The right-side elastic support portion 7R is a portion that elastically supports the movable body MB and includes a right-side upright portion 7R1, a first right-side deformed portion 7R2, a right-side folded portion 7R3, a second right side deformed portion 7R4, and a right-side fixed portion 7R5. The right-side upright portion 7R1 is a portion that connects the right end portion RE of the central portion 7C (see the top view of FIG. 3) and the first right side deformed portion 7R2. In this embodiment, the right-side upright portion 7R1 is formed by a bending process with the right end portion RE of the central portion 7C extending in the X-axis direction as a fold. The right-side upright portion 7R1 includes a portion formed linearly in a front view. In this embodiment, the right-side upright portion 7R1 is configured to extend downward (in the Z2 direction) perpendicularly to the central portion 7C. The first right side deformed portion 7R2 is a portion formed linearly in a top view. In this embodiment, the first right side deformed portion 7R2 is configured to extend rearward (in the X2 direction) from the right-side upright portion 7R1. The right-side folded portion 7R3 is configured to extend rightward (in the Y2 direction) from the rear end of the first right side deformed portion 7R2 and to protrude and curve rearward. In this embodiment, the right-side folded portion 7R3 is configured to have a U-shape in a top view so that stress acting on the right-side folded portion 7R3 is distributed over a wide range. The second right side deformed portion 7R4 is a portion formed linearly extending forward (in the X1 direction) from the right end of the right-side folded portion 7R3. The right-side fixed portion 7R5 is a portion fixed to the housing HS. In this embodiment, the right-side fixed portion 7R5 extends forward (in the X1 direction) from the front end of the second right side deformed portion 7R4 in parallel with the right-side plate portion 1A4 of the cover 1 and is fixed to the right-side plate portion 1A4 by welding. However, the right-side fixed portion 7R5 may be fixed to other portions of the housing HS, such as the front side plate portion 1A1, the rear side plate portion 1A3, the top plate portion 1B, or the base plate 2, by welding or the like. The first right side deformed portion 7R2, the right-side folded portion 7R3, and the second right side deformed portion 7R4 are also referred to as a right-side deformed portion 7RT (see the top view of FIG. 3), which is a portion that is deformed in response to the reciprocating motion of the movable body MB.

The left side portion 6L of the plate-like metal member 6 is configured to restrict the permanent magnet 5 (left side magnet 5L), which is attracted to the plate-like metal member 6 fixed to the central portion 7C, from moving leftward with respect to the plate-like metal member 6. The right-side portion 6R of the plate-like metal member 6 is configured to restrict the permanent magnet 5 (right side magnet 5R), which is attracted to the plate-like metal member 6 fixed to the central portion 7C, from moving rightward with respect to the plate-like metal member 6. The rear side portion 6B of the plate-like metal member 6 is configured to restrict the permanent magnet 5, which is attracted to the plate-like metal member 6 fixed to the central portion 7C, from moving rearward with respect to the plate-like metal member 6. The front side portion 6F of the plate-like metal member 6 is configured to restrict the permanent magnet 5, which is attracted to the plate-like metal member 6 fixed to the central portion 7C, from moving forward with respect to the plate-like metal member 6.

Specifically, the rear side portion 6B has a central rear side portion 6BC, a left rear side portion 6BL, and a right rear side portion 6BR, and the front side portion 6F has a central front side portion 6FC, a left front side portion 6FL, and a right front side portion 6FR. The left rear side portion 6BL and the left front side portion 6FL are configured to function as left-side stoppers for restricting movement of the movable body MB leftward (in the Y1 direction), and the right rear side portion 6BR and the right front side portion 6FR are configured to function as right-side stoppers for restricting movement of the movable body MB rightward (in the Y2 direction). Specifically, when the movable body MB moves leftward by a predetermined distance, the left rear side portion 6BL and the left front side portion 6FL come into contact with the inner surface of the left side plate portion 1A2 of the tubular portion 1A, thereby restricting further leftward movement of the movable body MB. Further, when the movable body MB moves rightward by a predetermined distance, the right rear side portion 6BR and the right front side portion 6FR come into contact with the inner surface of the right-side plate portion 1A4 of the tubular portion 1A, thereby restricting further rightward movement of the movable body MB.

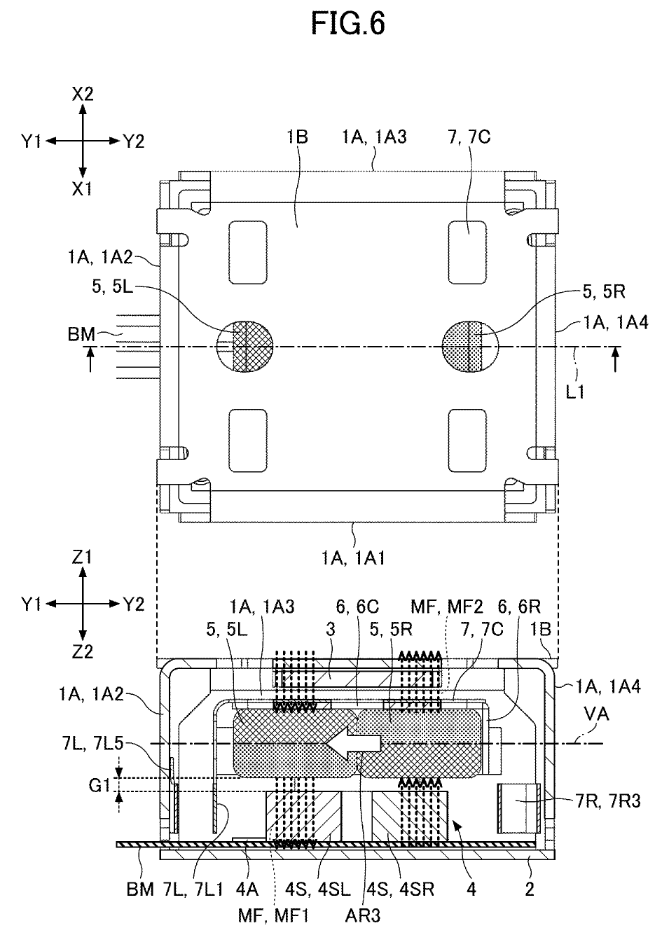

Next, with reference to FIGS. 6, 7, and 8, the reciprocating movement of the movable body MB caused by the driving unit DM will be described. FIG. 6 is a detailed view of the vibration generating device 101. Specifically, the upper view of FIG. 6 is a top view of the vibration generating device 101, and the lower view of FIG. 6 is a longitudinal cross-sectional view of the vibration generating device 101 taken along a virtual plane parallel to the YZ plane and including the dash-dot line L1 in the upper view of FIG. 6, as viewed from the X1 side. Specifically, the lower view of FIG. 6 illustrates a state in which the vibration generating device 101 is in an initial state. The initial state of the vibration generating device 101 refers to a state of the vibration generating device 101 in which no current is supplied to the coil 4.

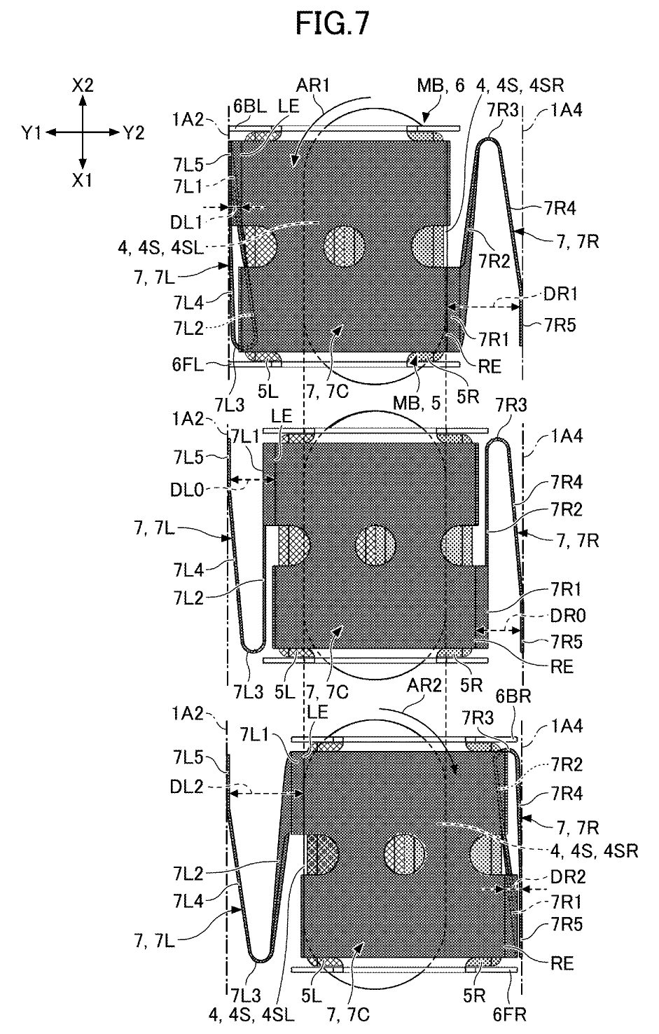

FIG. 7 is a top view of the coil 4, the movable body MB (the permanent magnet 5 and the plate-like metal member 6), and the support member 7. Specifically, the upper view of FIG. 7 illustrates a state in which the movable body MB is moved to the left (in the Y1 direction), the central view of FIG. 7 illustrates a state in which the movable body MB is in a neutral position (i.e., not moved), and the lower view of FIG. 7 illustrates a state in which the movable body MB is moved to the right (in the Y2 direction). In FIG. 7, for ease of illustration, portions of the coil 4 and the support member 7 that are actually hidden behind the movable body MB are illustrated by hidden lines (broken lines).

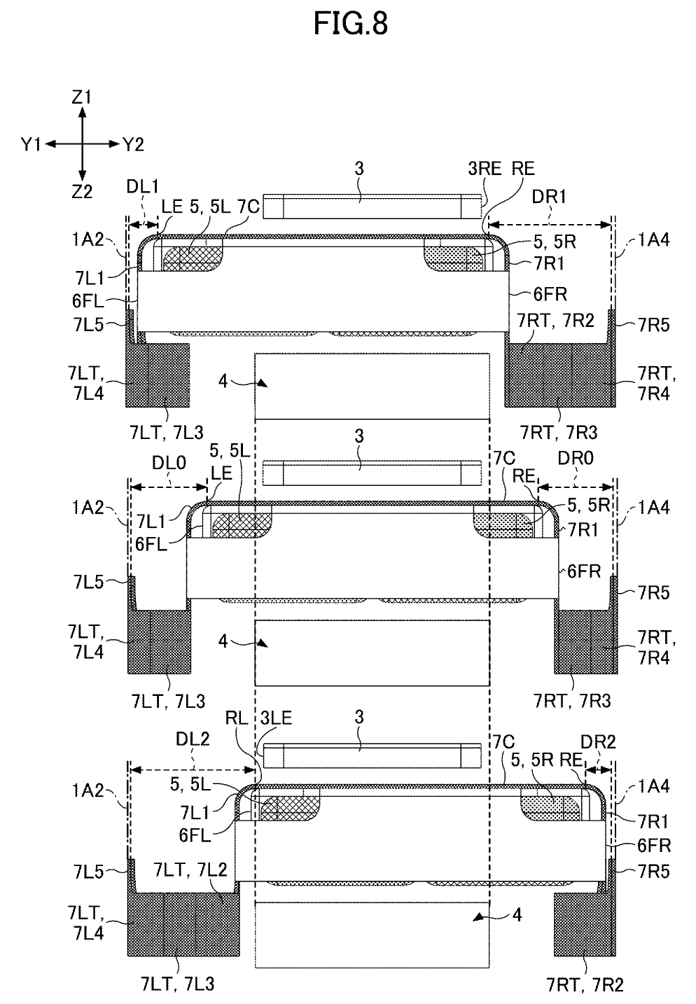

FIG. 8 is a front view of the conductive plate-like member 3, the coil 4, the movable body MB (the permanent magnet 5 and the plate-like metal member 6), and the support member 7. Specifically, the upper view of FIG. 8 illustrates a state in which the movable body MB is moved to the left (in the Y1 direction), the central view of FIG. 8 illustrates a state in which the movable body MB is in a neutral position (i.e., not moved), and the lower view of FIG. 8 illustrates a state in which the movable body MB is moved to the right (in the Y2 direction).

For example, as illustrated in the lower view of FIG. 6, the left side magnet 5L forming a part of the permanent magnet 5 has a lower half magnetized as an N pole and an upper half magnetized as an S pole. The right side magnet 5R forming a part of the permanent magnet 5 has a lower half magnetized as an S pole and an upper half magnetized as an N pole.

When a current flows from the first end portion 4A (see FIG. 2) to the second end portion 4B (see FIG. 2) of the coil 4, the current flows counterclockwise in a top view as indicated by an arrow AR1 in the upper view of FIG. 7. In this case, since a current flows from the rear side (X2 side) to the front side (X1 side) in the top view of a bundle wire portion 4S (left side bundle wire portion 4SL), which faces the left side magnet 5L of the coil 4 in the vertical direction and extends linearly along the front-rear direction in the initial state, a force that moves the left side magnet 5L in the left direction (Y1 direction) due to a Lorentz force acts on the left side magnet 5L. Further, since a current flows from the front side (X1 side) to the rear side (X2 side) in the top view of the bundle wire portion 4S (right side bundle wire portion 4SR), which faces the right side magnet 5R of the coil 4 in the vertical direction and extends linearly along the front-rear direction in the initial state, a force that moves the right side magnet 5R in the left direction (Y1 direction) due to a Lorentz force acts on the right side magnet 5R.

As a result, the movable body MB is biased in the left direction (Y1 direction) as illustrated by the block arrow AR3 in the lower view of FIG. 6, and moves to the left as illustrated in the upper view of FIG. 7 and the upper view of FIG. 8. When the movable body MB moves to the left by a predetermined distance, the left front side portion 6FL and the left rear side portion 6BL of the plate-like metal member 6 and the inner surface of the left side plate portion 1A2 of the tubular portion 1A come into contact with each other, thereby restricting further movement of the movable body MB to the left. In FIGS. 7 and 8, for ease of illustration, the position of the left side plate portion 1A2 of the tubular portion 1A is illustrated by a dash-dot line. The control unit CTR is typically configured to vibrate the movable body MB so that the left front side portion 6FL and the left rear side portion 6BL of the plate-like metal member 6 do not come into contact with the inner surface of the left side plate portion 1A2 of the tubular portion 1A.

In this case, the left side elastic support portion 7L is compressed so that the distance DL1 in the left-right direction (Y-axis direction) between the left end portion LE of the central portion 7C and the left side fixed portion 7L5 is smaller than the distance DL0 in the initial state (see the central view of FIG. 7), as illustrated in the upper view of FIG. 7. The right side elastic support portion 7R is extended so that the distance DR1 in the left-right direction (Y-axis direction) between the right end portion RE of the central portion 7C and the right side fixed portion 7R5 is larger than the distance DR0 in the initial state.

On the other hand, when a current flows from the second end portion 4B (see FIG. 2) to the first end portion 4A (see FIG. 2) of the coil 4, the current flows clockwise in a top view as indicated by the arrow AR2 in the lower view of FIG. 7. In this case, since a current flows from the front side (X1 side) to the rear side (X2 side) in the top view in the left side bundle wire portion 4SL, which faces the left side magnet 5L of the coil 4 in the vertical direction in the initial state, a force that moves the left side magnet 5L in the right direction (Y2 direction) due to a Lorentz force acts on the left side magnet 5L. Further, since a current flows from the rear side (X2 side) to the front side (X1 side) in the top view in the right side bundle wire portion 4SR, which faces the right side magnet 5R of the coil 4 in the vertical direction in the initial state, a force that moves the right side magnet 5R in the right direction (Y2 direction) due to a Lorentz force acts on the right side magnet 5R.

As a result, the movable body MB is biased in the right direction (Y2 direction) and moves rightward as illustrated in the lower views of FIG. 7 and FIG. 8. When the movable body MB moves rightward by a predetermined distance, the right front side portion 6FR and the right rear side portion 6BR of the plate-like metal member 6 come into contact with the inner surface of the right side plate portion 1A4 of the tubular portion 1A, thereby restricting further movement of the movable body MB to the right. In FIGS. 7 and 8, for ease of illustration, the position of the right side plate portion 1A4 of the tubular portion 1A is illustrated by a dash-dot line. The control unit CTR is typically configured to vibrate the movable body MB so that the right front side portion 6FR and the right rear side portion 6BR of the plate-like metal member 6 do not come into contact with the inner surface of the right side plate portion 1A4 of the tubular portion 1A.

In this case, as illustrated in the lower view of FIG. 7, the left side elastic support portion 7L is extended so that the distance DL2 in the left-right direction (Y-axis direction) between the left end portion LE of the central portion 7C and the left side fixed portion 7L5 is larger than the distance DL0 in the initial state (see the central view of FIG. 7). The right-side elastic support portion 7R is compressed so that the distance DR2 in the left-right direction (Y-axis direction) between the right end portion RE of the central portion 7C and the right-side fixed portion 7R5 is smaller than the distance DR0 in the initial state.

The control unit CTR can alternately generate a state illustrated in the upper view of FIG. 7 and a state illustrated in the lower view of FIG. 7, with the state illustrated in the central view of FIG. 7 interposed between the two states of the upper and lower views, by repeating the reversal of the direction of the current flowing through the coil 4 at a period corresponding to the natural frequency of the support member 7, for example.

Specifically, the control unit CTR stops the supply of current to the coil 4 when the vibration generating device 101 is in the state illustrated in the upper view of FIG. 7. When the supply of current to the coil 4 is stopped, the Lorentz force and the reaction force thereof disappear. At this time, the movable body MB is pushed back to the right (Y2 direction) by the restoring force of the support member 7. The same applies when the vibration generating device 101 enters the state illustrated in the lower view of FIG. 7.

Alternatively, the control unit CTR may reciprocate the movable body MB in the left-right direction by switching between supplying and stopping the current to the coil 4 without reversing the direction of the current flowing through the coil 4.

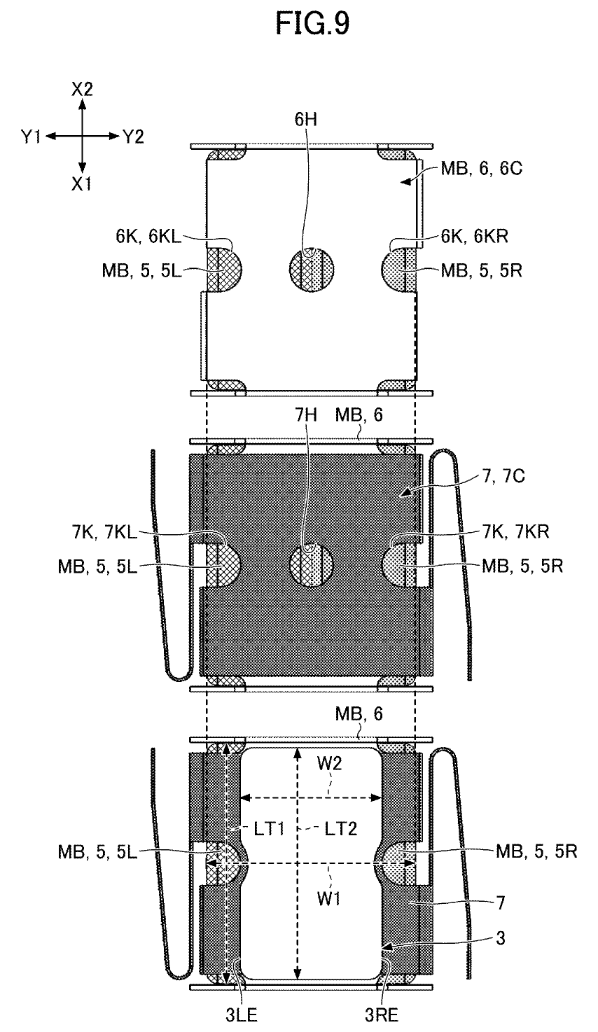

Next, with reference to FIG. 9, the positional relationship among the conductive plate-like member 3, the movable body MB, and the support member 7 will be described. FIG. 9 is a top view illustrating the conductive plate-like member 3, the movable body MB, and the support member 7. Specifically, the upper view of FIG. 9 is a top view of the movable body MB (including the permanent magnet 5 and the plate-like metal member 6), the central view of FIG. 9 is a top view of the movable body MB supported by the support member 7, and the lower view of FIG. 9 is a top view of the conductive plate-like member 3, the movable body MB, and the support member 7, illustrating the positional relationship among the conductive plate-like member 3, the movable body MB, and the support member 7.

As illustrated in the upper view of FIG. 9, the central portion 6C of the plate-like metal member 6 is formed with a through hole 6H and a cutout 6K exposing a portion of the upper surface of the permanent magnet 5. The cutout 6K includes a left side cutout 6KL exposing a portion of the upper surface of the left side magnet 5L and a right side cutout 6KR exposing a portion of the upper surface of the right side magnet 5R. As illustrated in the central view of FIG. 9, the central portion 7C of the support member 7 is also formed with a through hole 7H and a cutout 7K exposing a portion of the upper surface of the permanent magnet 5. The cutout 7K includes a left side cutout 7KL exposing a portion of the upper surface of the left side magnet 5L and a right-side cutout 7KR exposing a portion of the upper surface of the right-side magnet 5R. In the illustrated example, the position of the through hole 7H corresponds to the position of the through hole 6H, and the position of the cutout 7K corresponds to the position of the cutout 6K.

The through hole 6H and the cutout 6K have the effect that the magnetic flux generated by the permanent magnet 5 reaches the conductive plate-like member 3 more easily than when the through hole 6H and the cutout 6K are not formed in the central portion 6C of the plate-like metal member 6. The same applies to the through hole 7H and the cutout 7K as well.

As illustrated in the lower view of FIG. 9, the conductive plate-like member 3 is not formed with a through hole such as the through hole 6H of the plate-like metal member 6 or the through hole 7H of the support member 7 and is not formed with a cutout such as the cutout 6K of the plate-like metal member 6 or the cutout 7K of the support member 7. Therefore, eddy currents more easily flow in the conductive plate-like member 3 than when an opening or a cutout is formed. Further, since the conductive plate-like member 3 is flat as a whole and is not formed with concave portions, convex portions, and the like, eddy currents flow more easily than when the conductive plate-like member 3 is not flat but is formed with concave portions, convex portions, and the like.

Further, as illustrated in the lower view of FIG. 9, the conductive plate-like member 3 is configured to have a length LT2 shorter than the length LT1 of the permanent magnet 5 in the X-axis direction and a width W2 narrower than the width W1 of the permanent magnet 5 in the Y-axis direction. This configuration reduces the occurrence of portions through which the magnetic flux generated by the permanent magnet 5 does not pass. In the illustrated example, the width W2 of the conductive plate-like member 3 is set such that the position of the right end portion 3RE of the conductive plate-like member 3 and the position of the right end portion of the permanent magnet 5 (right side magnet 5R) in the Y-axis direction are substantially the same when the movable body MB (permanent magnet 5) moves to the left side (Y1 side) by a predetermined distance as illustrated in the upper view of FIG. 8, and the position of the left end portion 3LE of the conductive plate-like member 3 and the position of the left end portion of the permanent magnet 5 (left side magnet 5L) in the Y-axis direction are substantially the same when the movable body MB (permanent magnet 5) moves to the right side (Y2 side) by a predetermined distance as illustrated in the lower view of FIG. 8.

Further, in the illustrated example, when the movable body MB vibrates along the vibration axis VA, the magnetic flux MF generated by the permanent magnet 5 included in the movable body MB also vibrates along the vibration axis VA. That is, the magnetic flux crossing the conductive plate-like member 3 located above the permanent magnet 5 vibrates along the vibration axis VA while continuing to cross the conductive plate-like member 3. Therefore, an eddy current that reduces changes in the density of the magnetic flux crossing the conductive plate-like member 3 flows through the conductive plate-like member 3. The conductive plate-like member 3 is disposed so as to be orthogonal to the magnetic flux generated by the permanent magnet 5.

Therefore, the movable body MB receives a braking force caused by the eddy current, which acts in a direction opposite to the direction of vibration (movement). Specifically, the movable body MB is vibrated by the Lorentz force generated by the driving unit DM and receives a braking force which acts to decelerate the vibration. The braking force increases in proportion to the vibration speed of the movable body MB. Therefore, the vibration acceleration of the movable body MB at the natural frequency and at frequencies in the vicinity of the natural frequency is reduced by the braking force.

The braking force caused by the eddy current increases as the eddy current increases. The eddy current increases as the resistivity of the conductive plate-like member 3 decreases, increases as the electrical conductivity of the conductive plate-like member 3 increases, and increases as the thickness of the conductive plate-like member 3 increases. Therefore, the material and thickness of the conductive plate-like member 3 are selected so as to obtain a desired braking force. In the illustrated example, the conductive plate-like member 3 is formed of tough pitch copper, which is the same material as the wire material of the coil 4.

Further, in a vibration generating device, the braking force caused by the eddy current may be an undesirable force that reduces vibration acceleration. However, the vibration generating device 101 according to an embodiment of the present disclosure is configured to suppress resonance of the movable body MB by actively utilizing the braking force caused by the eddy current.

With this configuration, the vibration generating device 101 can suppress resonance of the movable body MB by using the braking force caused by the eddy current flowing through the conductive plate-like member 3.

As described above, the vibration generating device 101 according to the embodiment of the present disclosure, as illustrated in FIG. 2, includes a fixed body FB, a movable body MB, and a support member 7 configured to support the movable body MB so as to be able to vibrate along a first direction (Y-axis direction) with respect to the fixed body FB. The fixed body FB includes a coil 4 that includes a bundle wire portion 4S including a plurality of conductive wires extending in a second direction (X-axis direction) orthogonal to the first direction (Y-axis direction), and that is disposed on one side (Z2 side, lower side) of the movable body MB in a third direction (Z-axis direction) orthogonal to the first direction (Y-axis direction) and the second direction (X-axis direction). The movable body MB also includes the permanent magnet 5 configured to generate a first magnetic flux MF1 directed toward the bundle wire portion 4S side (Z2 side, lower side) and a second magnetic flux MF2 directed toward the opposite side (Z1 side, upper side) of the bundle wire portion 4S side, as illustrated in the lower view of FIG. 6. The fixed body FB further includes the conductive plate-like member 3 that is disposed on the other side (Z1 side, upper side) of the movable body MB in the third direction (Z-axis direction), extends along the first direction (Y-axis direction) so as to intersect the second magnetic flux MF2, and is configured to generate an eddy current when the movable body MB moves in the first direction (Y-axis direction), as illustrated in the lower view of FIG. 6.

With this configuration, the vibration generating device 101 can suppress resonance of the movable body MB by using the braking force caused by the eddy current flowing through the conductive plate-like member 3. Therefore, the vibration generating device 101 can improve durability while achieving an effect of suppressing resonance, as compared with a configuration in which resonance is suppressed using a gel-like damper member, a sponge, or the like. That is, this configuration provides an effect of providing the vibration generating device 101 having a structure excellent in durability and capable of suppressing resonance of the movable body MB.

In addition, this configuration can increase the damping coefficient as compared with a configuration in which resonance is suppressed by using a gel-like damper member, a sponge, or the like, and can achieve both responsiveness and peak acceleration. Further, this configuration can reduce distortion of the vibration waveform as compared with a configuration in which resonance is suppressed by using a gel-like damper member, a sponge, or the like. This is because, in a configuration in which resonance is suppressed by using a gel-like damper member, a sponge, or the like, the gel-like damper member or the sponge affects the spring constant of the support member 7 (leaf spring) and therefore tends to distort the vibration waveform.

In addition, the vibration generating device 101 has higher stability against environmental temperature as compared with a configuration in which resonance is suppressed by providing a magnetic fluid layer in a gap between a coil and a permanent magnet, or in a gap between a housing and a permanent magnet, or the like. That is, a change in performance due to a change in environmental temperature is unlikely to occur.

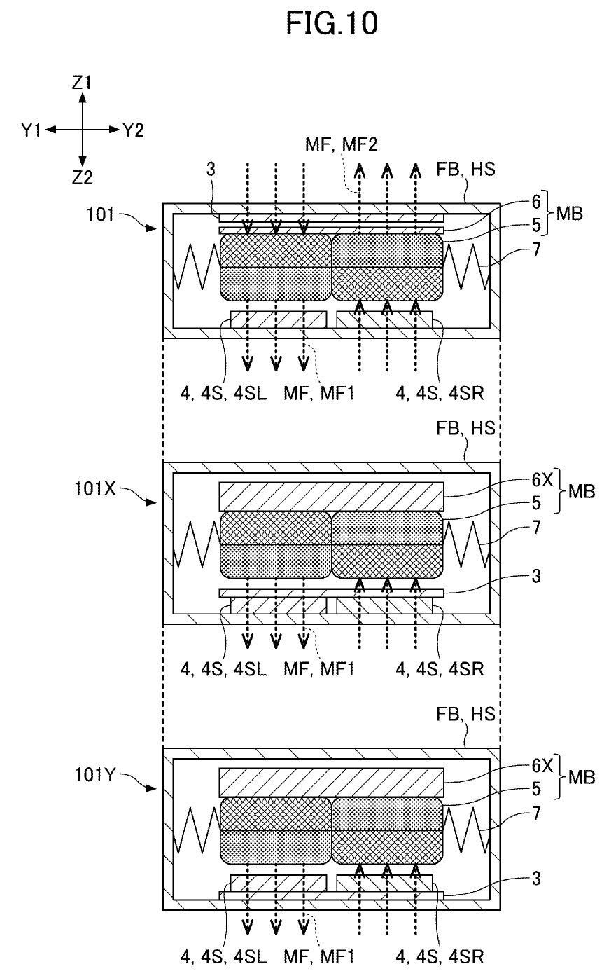

In addition, as compared with a configuration in which the conductive plate-like member 3 and the coil 4 are disposed on one side of the permanent magnet 5 (see the central and lower views of FIG. 10), this configuration can reduce the respective distances between the conductive plate-like member 3 and the permanent magnet 5 and between the coil 4 and the permanent magnet 5. Therefore, as compared with a configuration in which the conductive plate-like member 3 and the coil 4 are disposed on one side of the permanent magnet 5, this configuration can increase a braking force caused by an eddy current generated by interaction between the conductive plate-like member 3 and the permanent magnet 5 while suppressing a decrease in a driving force generated by interaction between the coil 4 and the permanent magnet 5, that is, while suppressing a decrease in a thrust constant.

FIG. 10 is a diagram illustrating the differences between the vibration generating device 101 according to an embodiment of the present disclosure and vibration generating devices 101X and 101Y as comparative examples. Specifically, the upper view of FIG. 10 is a schematic cross-sectional view of the vibration generating device 101 and corresponds to the lower view of FIG. 6. The central view of FIG. 10 is a schematic cross-sectional view of the vibration generating device 101X, and the lower view of FIG. 10 is a schematic cross-sectional view of the vibration generating device 101Y.

The vibration generating device 101X differs from the vibration generating device 101 in that it includes a plate-like metal member 6X functioning as a yoke plate instead of the plate-like metal member 6, and in that the conductive plate-like member 3 is disposed below the movable body MB and above the coil 4, while being the same as the vibration generating device 101 in other respects. The plate-like metal member 6X is formed to be thicker than the plate-like metal member 6 so as to function as a yoke member.

The vibration generating device 101Y differs from the vibration generating device 101 in that the vibration generating device 101Y includes the plate-like metal member 6X functioning as a yoke plate instead of the plate-like metal member 6, and in that the conductive plate-like member 3 is disposed below the movable body MB and below the coil 4, while being the same as the vibration generating device 101 in other respects. That is, the vibration generating device 101Y differs from the vibration generating device 101X in that the conductive plate-like member 3 is disposed below the coil 4, whereas the conductive plate-like member 3 in the vibration generating device 101X is disposed above the coil 4.

In the vibration generating device 101X, although the distance between the conductive plate-like member 3 and the permanent magnet 5 does not change as compared with the vibration generating device 101, the distance between the coil 4 and the permanent magnet 5 increases, and therefore the driving force generated by interaction between the coil 4 and the permanent magnet 5 decreases. On the other hand, in the vibration generating device 101Y, although the distance between the coil 4 and the permanent magnet 5 does not change as compared with the vibration generating device 101, the distance between the conductive plate-like member 3 and the permanent magnet 5 increases, and therefore the braking force caused by an eddy current generated by interaction between the conductive plate-like member 3 and the permanent magnet 5 decreases.

In contrast, in the vibration generating device 101, the distances between the conductive plate-like member 3 and the permanent magnet 5, and between the coil 4 and the permanent magnet 5 can be simultaneously decreased as compared with the vibration generating device 101X and the vibration generating device 101Y. Therefore, in the vibration generating device 101, the driving force caused by interaction between the coil 4 and the permanent magnet 5 can be increased as compared with the vibration generating device 101X, and the braking force due to eddy currents caused by interaction between the conductive plate-like member 3 and the permanent magnet 5 can be increased as compared with the vibration generating device 101Y.

Further, the vibration generating device 101 may be provided with the plate-like metal member 6 which is attracted to the upper surface of the permanent magnet 5, as illustrated in the diagram in FIG. 6. That is, the plate-like metal member 6 may be formed of a magnetic metal. In this case, the vibration generating device 101 may be configured so that the second magnetic flux MF2 passes from the upper surface of the permanent magnet 5 through the plate-like metal member 6 and is directed toward the conductive plate-like member 3. For example, the plate-like metal member 6 may be formed of a non-magnetic metal so as not to block the magnetic flux generated by the permanent magnet 5.

This configuration provides an effect that the permanent magnet 5 can be easily attached to the support member 7 through the plate-like metal member 6. This is because the permanent magnet 5 and the plate-like metal member 6 are bonded to each other by magnetic force without using an adhesive or the like. Furthermore, this arrangement provides an effect that a reduction in the braking force caused by the eddy current brought about by the interaction between the conductive plate-like member 3 and the permanent magnet 5 can be suppressed by the plate-like metal member 6.

Further, the plate-like metal member 6 may have the through hole 6H or a cutout 6K exposing the upper surface of the permanent magnet 5, as illustrated in the upper view of FIG. 9. In the illustrated example, a circular through hole 6H exposing the upper surface of the central portion of the permanent magnet 5, the left side cutout 6KL exposing the upper surface of the central portion of the left end portion of the left side magnet 5L, and a right side cutout 6KR exposing the upper surface of the central portion of the right end portion of the right side magnet 5R are formed in the central portion 6C of the plate-like metal member 6.

This configuration provides an effect that the magnetic flux generated by the permanent magnet 5 can easily reach the conductive plate-like member 3 and that the braking force caused by the eddy current brought about by the interaction between the conductive plate-like member 3 and the permanent magnet 5 can be increased, as compared with the arrangement in which the through hole 6H or the cutout 6K is not formed in the central portion 6C of the plate-like metal member 6.

The conductive plate-like member 3 may be a separate component from the fixed body FB. That is, the conductive plate-like member 3 may not be a part of the cover 1 or the base plate 2 that form the housing HS but may be a separate and independent component from the cover 1 and the base plate 2.

This configuration provides an effect that the braking force caused by the eddy current can be used to reduce the resonance of the movable body MB even when the housing HS is formed of a non-conductive material.

The conductive plate-like member 3 may be formed of a non-magnetic metal. This configuration provides an effect that a magnetic force (attraction force) can be prevented from acting between the conductive plate-like member 3 and the permanent magnet 5 as in the case where the conductive plate-like member 3 is formed of a magnetic metal, and that the efficient use of the driving force by the driving unit DM is prevented from being hindered by such attraction force.

The conductive plate-like member 3 may be formed of a material having an electrical conductivity higher than that of the fixed body FB. For example, the conductive plate-like member 3 may be formed of a material having an electrical conductivity higher than that of iron or an iron alloy. This configuration provides an effect that the braking force (force for reducing vibration) due to the eddy current can be increased. This is because the higher the electrical conductivity, the greater the braking force due to the eddy current. Therefore, this configuration provides an effect that, for example, resonance of the heavier movable body MB can be reduced.

Further, the conductive plate-like member 3 may be formed of copper or aluminum. For example, the conductive plate-like member 3 may be formed of copper, aluminum, or an alloy of copper or aluminum. This configuration provides an effect that material cost can be reduced as compared with the case where the conductive plate-like member 3 is formed of a noble metal such as silver or an alloy including silver.

The preferred embodiment of the present disclosure has been described in detail. However, the present disclosure is not limited to the above-described embodiments. Various modifications or substitutions may be applied to the above-described embodiments without departing from the scope of the present disclosure. In addition, each of the features described with reference to the above-described embodiments may be suitably combined so long as there is no technical conflict.

What is claimed is:

1. A vibration generating device comprising:
a fixed body;
a movable body; and
a support member configured to support the movable body so as to be able to vibrate along a first direction with respect to the fixed body,
wherein the fixed body includes a coil that includes a bundled wire portion including a plurality of conductive wires extending in a second direction orthogonal to the first direction, the coil being disposed on one side of the movable body in a third direction orthogonal to the first direction and the second direction,
wherein the movable body includes a permanent magnet configured to generate:
a first magnetic flux directed toward the bundled wire portion; and
a second magnetic flux directed toward a side opposite to the bundled wire portion; and
wherein the fixed body further includes a conductive plate-like member that is disposed on the other side of the movable body in the third direction, extends along the first direction so as to intersect the second magnetic flux, and is configured to generate an eddy current when the movable body moves along the first direction.

2. The vibration generating device according to claim 1, further comprising:
a plate-like metal member that is magnetically attracted to an upper surface of the permanent magnet,
wherein the second magnetic flux passes from the upper surface of the permanent magnet through the plate-like metal member and is directed toward the conductive plate-like member.

3. The vibration generating device according to claim 2,
wherein the plate-like metal member includes a through hole or a cutout that exposes the upper surface of the permanent magnet.

4. The vibration generating device according to claim 1,
wherein the conductive plate-like member is a component separate from the fixed body.

5. The vibration generating device according to claim 4,
wherein the conductive plate-like member is formed of a material having an electrical conductivity higher than an electrical conductivity of a material forming the fixed body.

6. The vibration generating device according to claim 5,
wherein the conductive plate-like member includes copper or aluminum.
